(19) United States
(12) Patent Application Publication
(10) Pub. No.: US 2014/0125897 A1
(43) Pub. Date: May 8, 2014

(54) ELECTRIC DEVICE HAVING VARIABLE CAPACITANCE ELEMENT AND ITS MANUFACTURE

(71) Applicant: FUJITSU LIMITED, Kawasaki-shi (JP)

(72) Inventors: Osamu TOYODA, Akashi (JP); Xiaoyu MI, Akashi (JP)

(73) Assignee: FUJITSU LIMITED, Kawasaki-shi (JP)

(21) Appl. No.: 14/154,533

(22) Filed: Jan. 14, 2014

Related U.S. Application Data
(63) Continuation of application No. PCT/JP2011/004537, filed on Aug. 10, 2011.

(51) Int. Cl. G02F 1/1343

(52) U.S. Cl. CPC G02F 1/1343
USPC 349/33; 349/187

(57) ABSTRACT

An electric device includes a dielectric substrate, a high frequency signal line formed on the surface of the dielectric substrate, a ground conductor facing the high frequency signal line through at least part of the thickness of the dielectric substrate, an upper electrode of capacitor disposed above the surface of the dielectric substrate and faces the high frequency signal line, and a liquid crystal material filled in a space defined between the high frequency signal line and the upper electrode of capacitor.

### CROSS REFERENCE TO RELATED APPLICATIONS

This application is a continuation application of the prior International Application No. PCT/JP2011/004537, filed on Aug. 10, 2011, the entire contents of which are incorporated herein by reference.

### FIELD

The embodiments of the present invention relate to an electric device having a variable capacitance element and its manufacturing method.

### BACKGROUND

In high frequency circuit, a capacitance is serially connected in a line or loaded on the line to adjust a distributed constant of the line. Use of the variable capacitance enables change of a resonance: frequency or change of distributed constant.

A typical variable capacitance element has such a structure in which a fixed electrode and a movable electrode are disposed to oppose each other, and the capacitance is changed by displacing the movable electrode. The movable electrode can be displaced piezoelectrically or electrostatically. It is desired to form a variable capacitance element realizing required capacitance change with as simple and small sized structure as possible. Reduction in the size and weight is highly demanded in mobile electronic device, and variable capacitance elements using MEMS (micro electro mechanical system) have been developed.

In a known structure, a fixed electrode is formed on a support substrate, and the movable electrode is formed above the fixed electrode with intervening flexible beams or the like. A driver electrode, is formed to oppose the movable electrode, and a drive voltage is applied between the driver electrode and the movable electrode to thereby regulate the distance between the fixed electrode and the movable electrode by electrostatic drive and change the capacitance (see, for example, Japanese Patent Application Laid-Open No. 2009-83011). For example, when the distance between the driver electrode and the movable electrode is about 3 μm, a voltage of several tens V to a hundred and several tens V is applied as the drive voltage.

When the fixed electrode is covered with a dielectric film, the electrode may cause phenomenon called “sticking” since repeated on-off actions may charge up the dielectric film or weaken restoring force of the flexible beam, and there may occur sticking of the movable electrode to the dielectric film even when external power has been turned off. This problem is still unsolved despite an investigation of the countermeasure by driving waveform.

There is also a phenomenon called “self-actuation” wherein the movable electrode moves by an electric potential difference caused by signal wave pattern of the high frequency signal. A countermeasure for preventing the self actuation is increasing of resilience of the flexible beam (namely, increasing of the drive voltage) depending on a power of the signal. However, increase in the drive voltage is associated with an increased risk of the phenomenon called “sticking”, and a voltage increasing circuit may be necessary to realize the increased voltage.

An capacitance value can be increased by filling space between the opposing electrodes constituting the capacitance with a dielectric substance having a high dielectric constant. In other words, the same structure can function as a variable capacitance when the space between the opposing electrodes is filled with a material with changing dielectric constant, and the dielectric constant of the material is changed.

A liquid crystal molecule has elongated morphology extending in the direction of the molecular axis, and the dielectric constant differs whether an electric vector is in the direction of the major axis or the minor axis. When a liquid crystal layer is sandwiched between opposing electrodes, the dielectric constant of the liquid crystal layer can be changed by controlling the orientation of the liquid crystal molecule. In positive nematic liquid crystal, the dielectric constant in the direction of the major axis (director) of the liquid crystal molecule is higher than the dielectric constant in the minor axis direction (positive anisotropy of the dielectric constant). For example, the dielectric constant increases when the positive nematic liquid crystal is filled between the opposing electrodes, and orientation of the liquid crystal molecules is changed from the direction parallel to the plane of the electrode to the direction perpendicular to the plane of the electrode (for example, Japanese Patent Application Laid-Open No. 2003-17912). More specifically, a micro-strip resonator may be constituted by arranging a first ceramic substrate having a strip conductor connected to the input/output line and a second ceramic substrate having a ground conductor to oppose each other, and the liquid crystal may be introduced in the space between the opposing first and second ceramic substrates. A voltage source for regulation may be connected to the strip conductor, and a direct current or a low frequency alternating current voltage may be applied to the space between the strip conductor and the ground conductor. The dielectric constant of the liquid crystal layer changes depending on the output voltage of the regulation voltage source, and the resonance frequency of the micro-strip resonator is thereby changed,

Liquid crystal materials have low responsivity of high frequency, and therefore, the orientation of the liquid crystal can be regulated by a direct current or low frequency) signal which is different from the high frequency signal. However, when the space between the high frequency line and the ground plane, namely, the medium itself where the high frequency is transmitted is filled with the liquid crystal, the liquid crystal layer which is the transmission medium would not be practical layer unless it has a thickness of approximately 200 μm to 800 μm due to increased propagation loss of the high frequency. Furthermore, the time required for the change of the liquid crystal orientation is proportional to the square of the thickness of the liquid crystal layer. In typical liquid crystal display, the liquid crystal layer often has a thickness of several μm, and for example, when a liquid crystal wherein the orientation changes in approximately 50 msec upon application of the voltage of 3 V to 5 V to the liquid crystal layer having a thickness of 5 μm is used, and a variable capacitance having the liquid crystal layer thickness of 200 μm is formed, the time required for the change of the orientation is as long as approximately 80 seconds, and this is not at all practical.

### SUMMARY

According to an aspect of the present invention, an electric device having a variable capacitance element includes: a dielectric substrate; a high frequency signal line formed on a surface of the dielectric substrate; a ground conductor disposed to oppose the high frequency signal line with at least part of the dielectric substrate intervening the ground conductor and the high frequency signal line; upper electrode, of capacitor disposed above the surface of the dielectric substrate, opposing the high frequency signal line; and liquid crystal material filled in a space between the high frequency signal line and the upper electrode of capacitor.

According to another aspect of the present invention, a method for manufacturing an electric device having a variable capacitance element, includes the steps of: preparing a dielectric substrate having a ground conductor; forming a high frequency signal line on a surface of the dielectric substrate; forming an upper electrode of capacitor extending above the high frequency signal line, defining space for accommodating liquid crystal between the high frequency signal line and the upper electrode of capacitor; and filling liquid crystal in the space for accommodating liquid crystal.

The object and advantages of the invent ion will be realized and attained by means of the elements and combinations particularly pointed out in the claims.

It is to be understood that both the foregoing general description and the following detailed description are exemplary and are not restrictive of the invention, as claimed.

### BRIEF DESCRIPTION OF DRAWINGS

FIG. 1A is a plan view of a distributed constant type capacity coupling two-stage filter, FIGS. 1B and 1C are perspective views illustrating structure of variable capacitance of two kinds which may be included in the filter, FIG. 1D is an equivalent circuit diagram of the filter, FIG. 1E is a cross-sectional view illustrating structure of a variable capacitance, and FIG. 1F is a cross-sectional view illustrating the state wherein the liquid crystal droplets have been applied into the space between the opposing electrodes of the variable capacitance illustrated in FIG. 1E, according to the first embodiment.

FIGS. 2A, 2B, and 2C are a graph simply illustrating the results of the measurement of samples S1 and S2, and cross-sectional views illustrating the structure of the samples S1 and S2.

FIGS. 3A to 3K are cross-sectional views illustrating manufacturing processes and the resulting structure of the electric device having a variable capacitance element according to first embodiment.

FIGS. 4A to 4F are cross-sectional views and a perspective view illustrating a modification of the first embodiment.

FIGS. 5A, 5B, and 5C are a perspective view illustrating a variable capacitance element according to second embodiment, and cross-sectional views illustrating operation states of the variable capacitance element.

FIGS. 6A to 6H are cross-sectional views illustrating manufacturing processes of the variable capacitance element according to the second embodiment.

FIGS. 7A, 7B, and 7C are cross-sectional views illustrating modifications of the second embodiment.

FIGS. 8A and 8B are a plan view and a cross-sectional view illustrating a variable capacitor according to third embodiment.

FIGS. 9A and 9B are a cross-sectional view and an assembling diagram illustrating a variable capacitor according to fourth embodiment.

### DESCRIPTION OF EMBODIMENTS

The inventors of the present invention investigated use of the liquid crystal in the variable capacitance of high frequency circuit. A micro-strip structure having a distributed constant capacity coupling two-stage filter formed on a LTCC (low temperature co-fired ceramic) substrate having a ground conductor extending on the rear surface of or in the substrate was used for the sample of the high frequency circuit. In the micro strip line wherein the ground (earth) conductor and a high frequency signal line are formed on the surface of the substrate or in the ceramic substrate with at least a part of the ceramic substrate intervening the ground conductor and the high frequency signal line. The high frequency transmission space between the ground conductor and the high frequency signal line is constituted of ceramics, and therefore, high frequency transmission characteristics can be easily secured. The loss of the high frequency transmission would be suppressed if liquid crystal is used for capacitor dielectric substance of a variable capacitance loaded on the high frequency line.

Nematic liquid crystal is a liquid crystal in which marked change in the specific dielectric constant (inductivity) can be induced by the orientation change of the liquid crystal. A positive nematic liquid crystal with the difference in the specific dielectric constant Δε₃ of 32.4 was used. The liquid crystal molecules of the positive nematic liquid crystal have dielectric constant anisotropy, and the specific dielectric constant in the direction of major axis (director direction) is higher than the dielectric constant in the direction of minor axis. In liquid crystal displays, a positive nematic liquid crystal layer is sandwiched between opposing substrates formed with the opposing electrodes, and a voltage is selectively applied between the opposing electrodes. In the state with no voltage application (off state), the director of the liquid crystal molecules of the liquid crystal layer is parallel to the plane of the electrode when an alignment film is formed and orientation treatment for alignment of the liquid crystal in the direction parallel to the plane of the electrode is conducted, or random when such alignment film is not formed. When on-voltage is applied (on state), the director of the liquid crystal molecule, of the liquid crystal layer becomes perpendicular to the plane of the electrode.

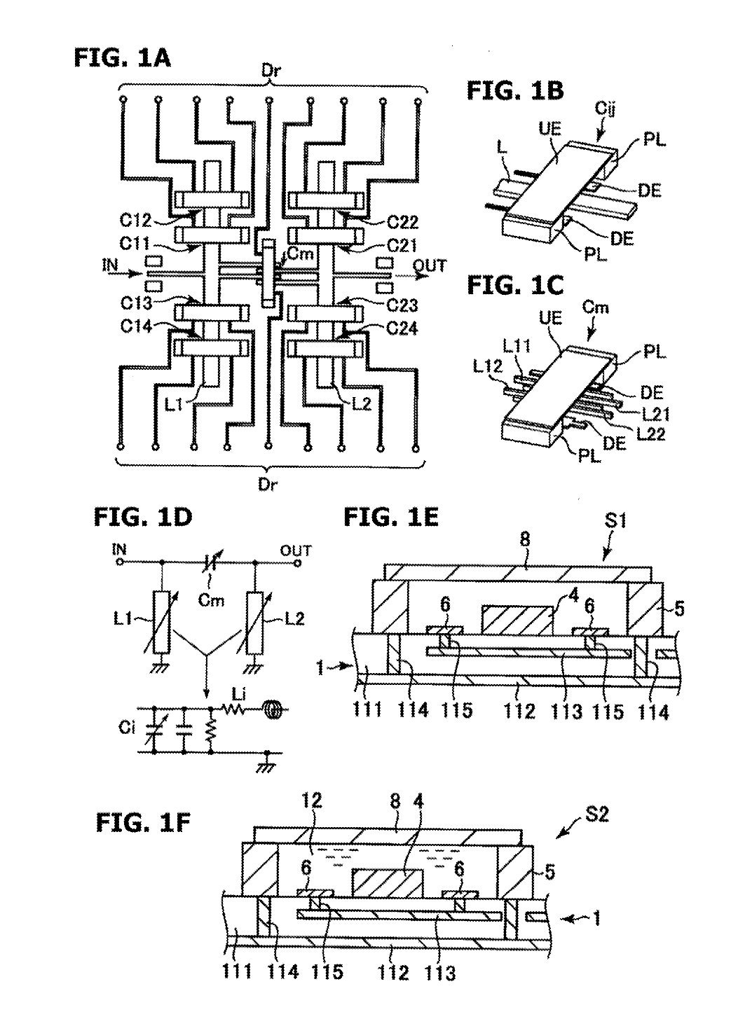

FIG. 1A is a plan view of the distributed constant type capacity coupling two stage filter. The structure as illustrated in FIG. 1A is formed on the LTCC substrate having a ground conductor on the rear surface. High frequency signals are transmitted from an input terminal “IN” on the left side to an output terminal “OUT” on the right side through a coupling variable capacitance Cm. A distributed constant line L1 is connected to the high frequency signal line on the input side of the coupling variable capacitance Cm, and a distributed constant line L2 is connected to the high frequency signal line on the output side of the coupling variable capacitance Cm. Variable capacitances C₁₁, C₁₂, C₁₃, and C₁₄ are loaded on the line L1 to constitute a distributed constant line, and variable capacitances C₂₁, C₂₂, C₂₃, and C₂₄ are loaded on the line L2 to constitute a distributed constant line.

FIG. 1B illustrates constitution of the variable capacitance Cij (wherein i is 1 or 2, j is any one of 1 to 4). Driver electrodes DE are formed on the surface of the substrate on both (opposite) sides of the line L, and a pair of pillar-shaped conductive supports PL are formed outside the driver electrodes DE. An upper electrode UE of capacitor having a (double supported or fixed) beam structure at opposite ends with pillar-shaped conductive supports PL opposes the line L to define the variable capacitance. The pillar-shaped conductive support PL, namely, the upper electrode UE of capacitor is connected to a constant electric potential, for example, is grounded. When a positive (or negative) drive voltage is applied to the driver electrode DE, electrostatic attraction is generated between the upper electrode UE of capacitor and the driver electrode DE. The upper electrode UE of capacitor is displaced downward depending on the electrostatic attraction and the capacitance formed between the upper electrode UE of capacitor and the line L increases with the downward displacement of the upper electrode UE of capacitor. The variable capacitance functions in this way.

FIG. 1C illustrates constitution of the coupling variable capacitance Cm. Two input side high frequency lines L11 and L12 and two output side high frequency lines L21 and L22 are alternately arranged on the coupling region of the surface of the substrate. The driver electrodes DE are formed on both outer sides of the high frequency line L11, L12, L21, and L22, and a pair of pillar-shaped conductive supports PL are formed outside the driver electrodes DE. The upper electrode UE of capacitor supported at both ends by the pillar-shaped conductive supports PL opposes or faces the high frequency lines L11, L12, L21, and L22, and forms variable capacitances with them. The pillar-shaped conductive supports PL and the upper electrode UE of capacitor are connected to a constant electric potential, for example, grounded, and a drive voltage is applied to the driver electrode DE for the function of the variable capacitor as in the case of FIG. 1B.

FIG. 1D illustrates an equivalent circuit of the distributed constant capacitance coupling two-stage filter. The input terminal IN is connected to the output terminal OUT by the intervening coupling variable capacitance Cm. A distributed constant line L1 is connected to the input side high frequency line, and a distributed constant line L2 is connected to the output side high frequency line. The distributed constant lines L1 and L2 may be respectively approximated as a circuit having a variable capacitance Ci, fixed capacitance, inductance Li, and resistance component.

FIG. 1E is a schematic cross-sectional view illustrating the variable capacitance Cij of FIG. 1B. The substrate 1 is a LTCC substrate having a ground conductor 112 of, for example, silver on the rear surface and an internal wiring 113 of, for example, silver in the interior. The high frequency line 4, the driver electrode 6, and the pillar-shaped conductive supports 5 of, for example, gold are formed on the surface of the substrate 1, and the capacitor upper electrode 8 of, for example, gold is double supported or fixed at its opposite ends by the pillar-shaped conductive supports 5. Through via conductors 114 connect the pillar-shaped conductive supports 5 with a ground conductor 112, and via conductors 115 connect the driver electrode 6 with the internal wiring 113. When a voltage is applied between the driver electrodes 6 and the grounded capacitor upper electrode 8, the capacitor upper electrode 8 is attracted toward the driver electrodes 6 by the electrostatic attraction. The upward and downward displacements of the capacitor upper electrode 8 constitute the function of variable capacitance. The distributed constant capacitance coupling two-stage filter having the space between the opposing electrodes of the variable capacitor filled with air is designated as sample S1.

FIG. 1F illustrates a structure in which the space between the upper electrode 8 and the opposing electrodes 4 and 6 of the variable capacitor Cij is filled with liquid crystal 12 by droplet introduction. The coupling variable capacitance Cm also has its space between the opposing electrodes filled with the liquid crystal 12 by droplet introduction as in the case of the variable capacitance Cij. The distributed constant capacitance coupling two-stage filter having the space between the opposing electrodes of the variable capacitance filled with the liquid crystal is designated as sample S2.

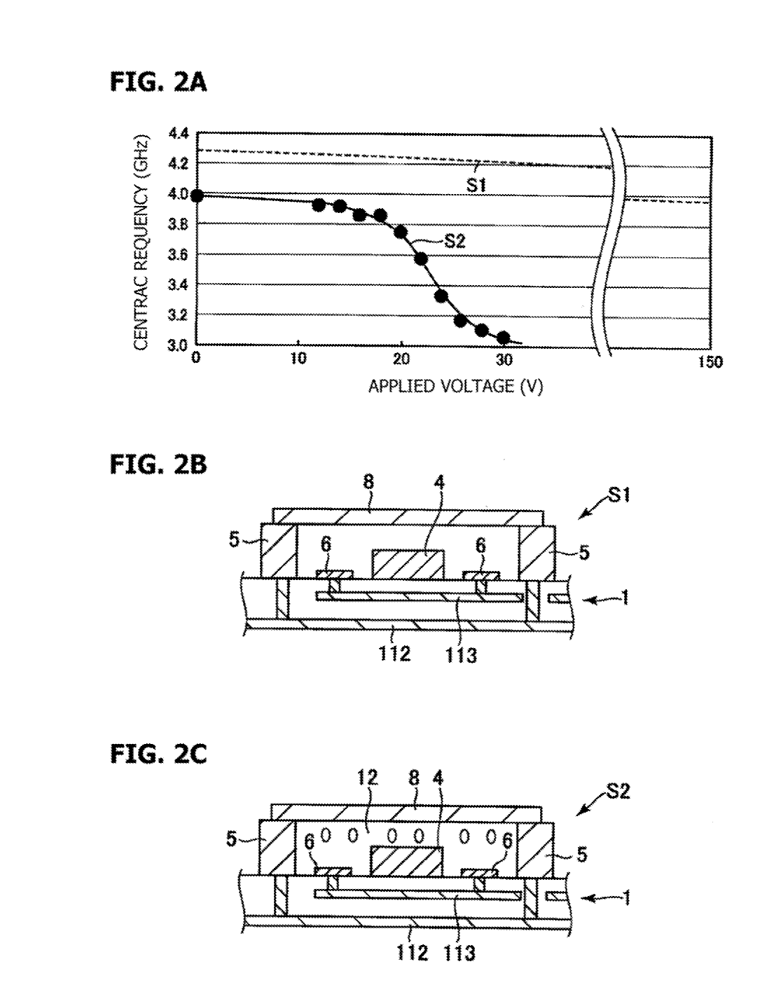

FIG. 2A is a graph illustrating the change of resonance frequency of the distributed constant capacitance coupling two-stage filter when a voltage is applied to the driver electrodes 6 of the sample. The central frequency was measured by measuring filter characteristics by a network analyzer while applying direct current voltage to the driver electrodes 6 of each variable capacitor. The x axis illustrates the voltage applied in the unit (V), and the y axis illustrates the central frequency in the unit (GHz).

FIGS. 2B and 2C are schematic cross-sectional views illustrating the constitution of the samples S1 and S2. In FIG. 2B, the space between the opposing electrodes of the variable capacitance is filled with air as in the case of FIG. 1E. In the sample S1, the central frequency was 4.28 GHz when the voltage applied is 0 V and while the central frequency was 3.93 GHz when the voltage applied is 150 V. In other words, difference in the applied voltage of 0 V to 150 V resulted in the downward displacement of the upper electrode 8 and change in the central frequency of 0.35 GHz.

FIG. 2C is sample S2 having the space between the opposing electrodes of the variable capacitance filled with a nematic liquid crystal 12 having a specific dielectric constant Δε₃ of 32.4 by droplet application. The space between the micro-strip line 4 and the grounded conductor 112 is filled, for example, with the ceramics of the LTCC substrate, and the sample S2 is expected to illustrate the high frequency characteristics like those of FIG. 2B. The variable capacitance having the space between the electrodes filled with the nematic liquid crystal 12 is only loaded to the high frequency line 4, and the deterioration of the high frequency characteristics is considered to be suppressed. Sample S2 constitutes the first embodiment.

When a drive voltage is applied to the driver electrodes 6, an electric field is generated in the space between the upper electrode 8 and the driver electrodes 6, and the molecules of the liquid crystal are considered to be vertically oriented. At the applied voltage of 0 V, the central frequency was about 4 GHz, and with the increase in the applied voltage, the central frequency starts to reduce around a voltage of ten and several V, and becomes about 3 GHz at 30 V. While application of the voltage of 30 V in the sample S1 only results in the frequency change of but 0.1 GHz, application of 30 V in the sample S2 results in the frequency change of about 1 GHz. The capacitance change upon displacement of the upper electrode is considered to become large since the space between the electrodes is filled with dielectric material having a large dielectric constant. There occurs a large capacitance change which can not be ascribed only to this reason. Liquid crystal molecules distributed in near region have property that they are not independently change orientation, but collectively change orientation. Although no voltage is applied between the high frequency line 4 and the upper electrode 8, it is considered that orientation of the liquid crystal molecules is changed, considered from the results of measurements. It is considered that the liquid crystal molecules have changed from random orientation to substantially vertical orientation with respect to the electrode surface.

The change in the central frequency in response to the change of the applied voltage of 30 V for the sample S2 is higher than that of the sample S1 by an order of magnitude. When the case of applying a voltage of 150 V to the sample S1 is compared with the case of applying a voltage of 30 V to the sample S2, about 3 times larger change of the central frequency is obtained by the application of ⅕ voltage. Filling the space between the electrodes of the variable capacitance with the liquid crystal enables reduction of drive voltage and/or increase the change of the capacitance (frequency).

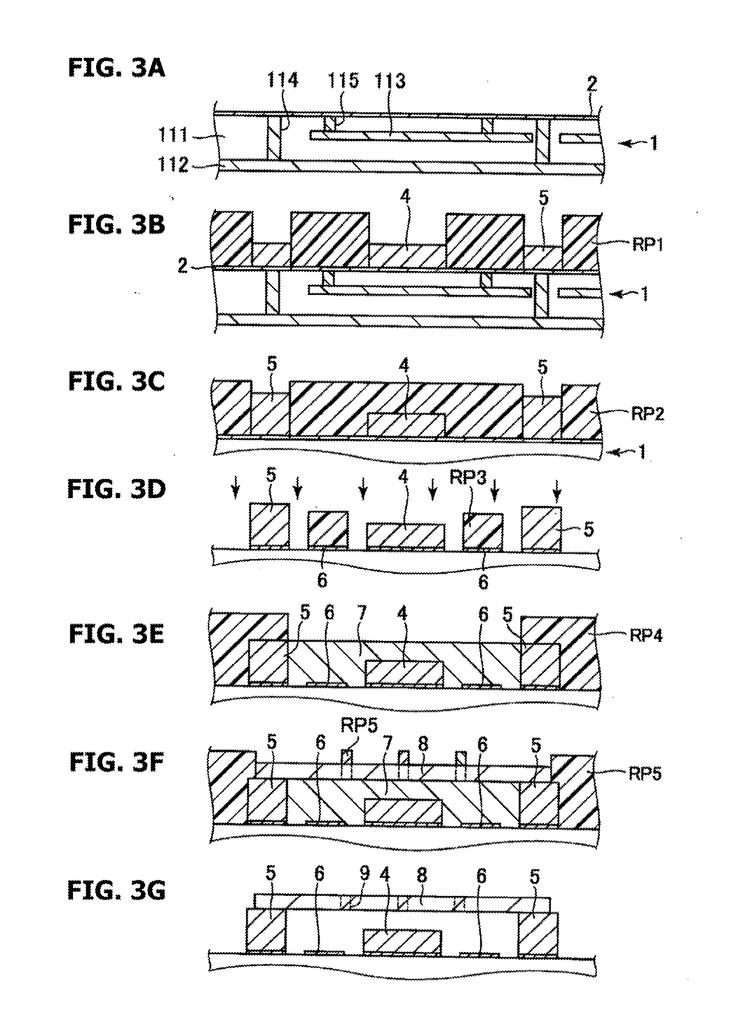

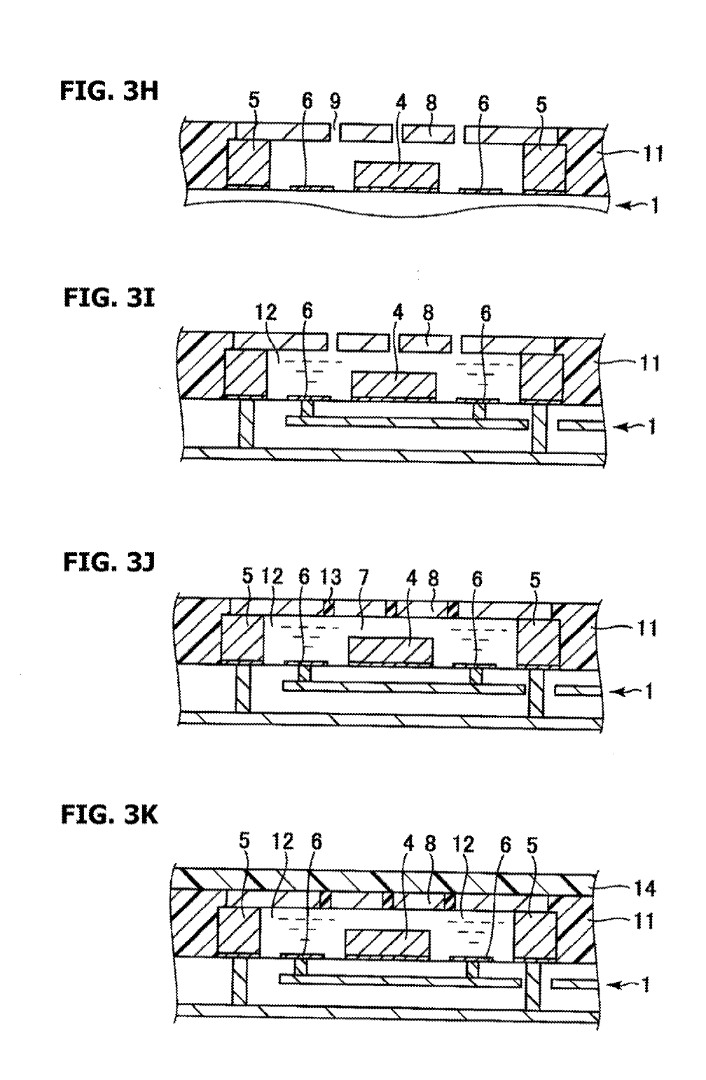

FIGS. 3A to 3K are schematic cross-sectional views illustrating the processes for manufacturing the variable capacitance illustrated in FIGS. 1F and 2C.

As illustrated in FIG. 3A, the LTCC substrate 1 has a ground conductor 112 disposed on the rear surface (or in the interior of the substrate), and a wiring 113 and conductive vias 114 and 115 disposed in the interior. On the surface of this LTCC substrate 1, a gold layer 2 having a thickness of approximately 0.5 μm is formed, for example, by sputtering (a Ti film or the like may be formed under the gold layer as the adhesion film in contact with the LTCC substrate). The gold layer 2 functions as a seed layer in the following plating step, and also forms the driver electrode after patterning.

As illustrated in FIG. 3B, a resist pattern RP1 having openings in the areas to be plated is formed on the seed layer 2. The regions where a high frequency line 4 and pillar-shaped conductive supports 5 are formed are thereby defined. Electrolytic plating of gold is done using the seed layer 2 as electrode, to form a gold layer on the seed layer 2 exposed in the openings of the resist pattern RP1. The high frequency line 4 and lower parts of the pillar-shaped conductive supports 5 are formed. Thereafter, the resist pattern RP1 is removed.

As illustrated in FIG. 3C, a resist pattern RP2 having openings in the areas where the pillar-shaped conductive supports 5 are to be formed is formed. The high frequency line 4 is covered with the resist pattern RP2. Electrolytic plating of gold is further done to form the remaining thickness of the pillar-shaped conductive supports 5. Thereafter, the resist pattern RP2 is removed.

As illustrated in FIG. 3D, a resist pattern RP3 having the pattern of driver electrodes is formed. The exposed gold layer 2 is removed by milling using Ar ions to leave driver electrodes 6. While the high frequency line 4 and the pillar-shaped conductive supports 5 are also milled, sufficient thickness of the high frequency line 4 and the pillar-shaped conductive supports 5 remain. If desired, a resist pattern may be formed on the high frequency line 4 and the pillar-shaped conductive supports 5. Thereafter, the resist pattern RP3 is removed.

As illustrated in FIG. 3E, a copper layer is formed by sputtering to form a seed layer, then, a resist pattern RP4 having an opening defining a space between the electrodes of the variable capacitance is formed, and a copper layer 7 is electrolytically plated to form a dummy (sacrificial) layer. Thereafter, the resist pattern RP4 is removed.

As illustrated in FIG. 3F, a resist pattern RP5 having an opening in the area of the upper electrode of the variable capacitance is formed. The upper surfaces of the dummy copper layer 7 and the pillar-shaped conductive supports 5 are selectively exposed. Electrolytic plating of gold is done to form a gold layer functioning as the upper electrode 8. If desired, pattern for forming through openings in the upper electrode 8 can be added to the resist pattern RP5 for use in introducing liquid crystal. Thereafter, the resist pattern RP5 is removed.

As illustrated in FIG. 3G, the dummy copper layer 7 (sacrificial layer) is removed by etching. FIG. 3G illustrates the case wherein the upper electrode 8 has through openings 9.

As illustrated in FIG. 3H, a resin layer 11 surrounding the variable capacitance region is formed. For example, a photosensitive negative type polyimide resin layer is coated and exposed for development to leave the exposed part to thereby form the resin package region 11 surrounding the variable capacitance cell region. When the upper electrode 8 is not formed with the through opening(s) for liquid crystal introduction, the resin package region 11 may, for example, be selectively formed to leave liquid crystal inlet opening(s) above the high frequency line 4. When the upper electrode 8 is formed with through opening(s) for liquid crystal introduction, the resin package region 11 may perfectly surround the variable capacitance cell region.

As illustrated in FIG. 3I, the liquid crystal 12 is introduced in the space between the electrodes of the variable capacitance. For example, the atmosphere is exhausted or evacuated to vacuum, and the substrate is immersed in liquid crystal to inject liquid crystal by vacuum. Excess liquid crystal is removed by squeegee or the like.

As illustrated in FIG. 3J, sealing resin is filled in the liquid crystal inlet opening(s), and cured to form seal 13.

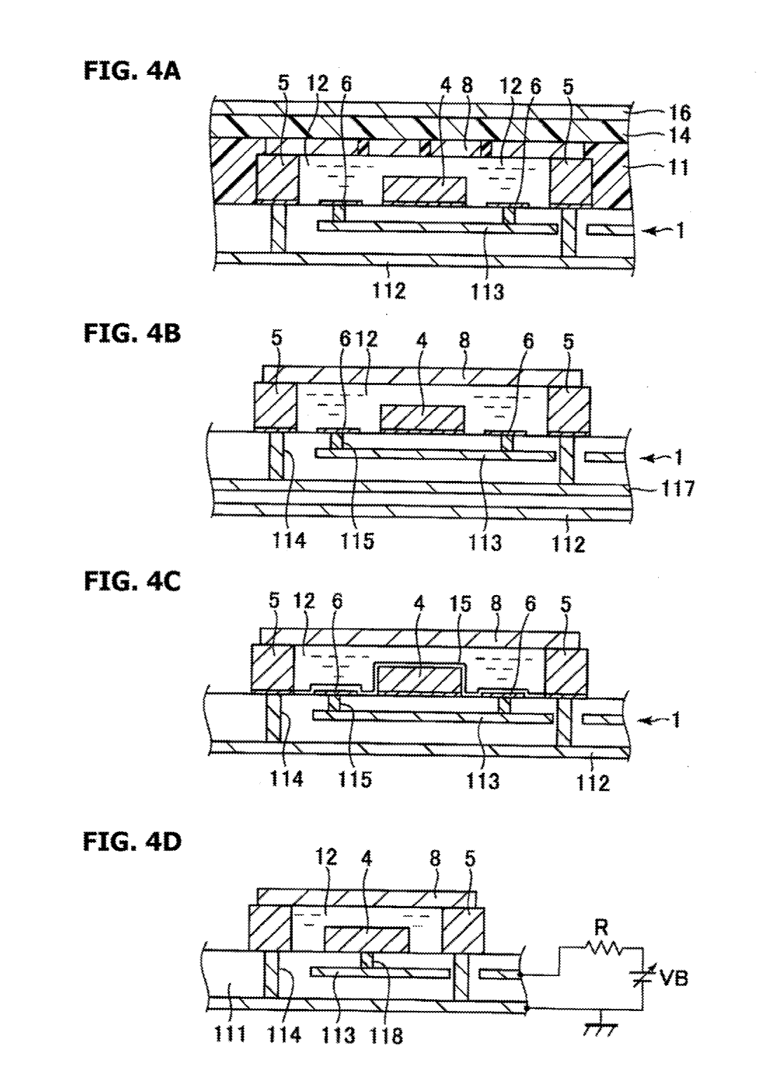

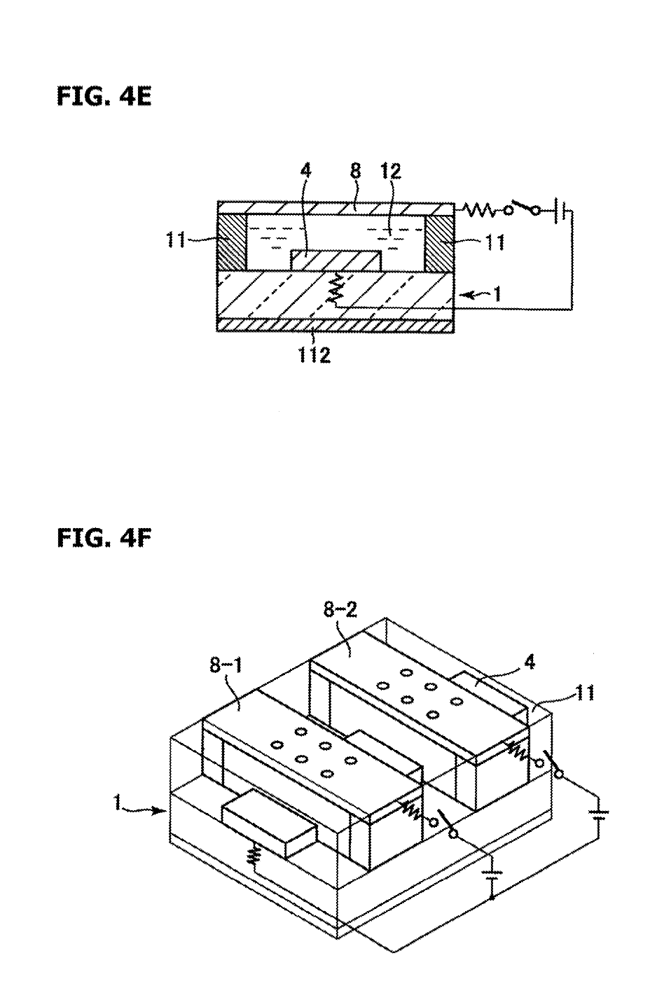

As illustrated in FIG. 3K, a resin package layer 14 is formed to cover the upper electrode 8. The electric device having the variable capacitance illustrated in FIGS. 1F and 2C is produced. The variable capacitance illustrated in FIGS. 1F and 2C can be modified in various ways. Such modifications are illustrated in FIGS. 4A to 4F.

As illustrated in FIG. 4A after making the structure illustrated in FIG. 3K, another ground conductor 16 may be formed on the resin package layer 14 to produce a strip line structure.

As illustrated in FIG. 4B, a wiring layer 117 may be provided in the substrate 1 for use as a ground wiring for the direct current bias in addition to the ground conductor 112 for the high frequency line. The upper electrode 8 is connected to the ground wiring 117 via the intervening pillar-shaped conductive supports 5 and via conductor 114. The internal wiring is two-layered in FIG. 4B. The number of the layers of the internal wiring may be arbitrarily selected.

As illustrated in FIG. 4C, an alignment film 15 may be formed on the surface of the substrate 1, which contacts the liquid crystal. Formation of horizontal alignment film results in stable alignment of the liquid crystal molecules parallel to the substrate surface. The orientation can be controlled by the alignment treatment such as rubbing and light (UV light) irradiation.

As illustrated in FIG. 4D, the driver electrode 6 may be omitted, and a direct current bias may be applied to the high frequency line 4 from the variable bias power source VB via resistance R. The resistance R may be, for example, at least 5 kΩ, and then, leakage of the high frequency hardly occurs. When desired capacitance change of the capacitor is obtained by the orientation change of the liquid crystal molecules, displacement of the upper electrode 8 of the variable capacitor may be dispensed with. The upper electrode 8 may not be flexible. The size of the variable capacitor can be reduced without considering the flexibility.

As illustrated in FIG. 4E, an insulated body 11 of resin or the like may be formed on the substrate 1, and the upper electrode 8 may be supported thereon. A direct current bias circuit may be connected between the upper electrode 8 and the high frequency line 4 through resistance.

As illustrated in FIG. 4F, plural upper electrodes 8-1, 8-2, and so on may be formed above the high frequency line 4, and direct currant bias circuits may be connected between the high frequency line 4 and the upper electrodes 8-i via resistances.

The bias voltage source of FIGS. 4E and 4F may be fixed voltage source in the case of digital variable capacitor. Variable bias voltage circuit may be used to constitute an analogue variable capacitor.

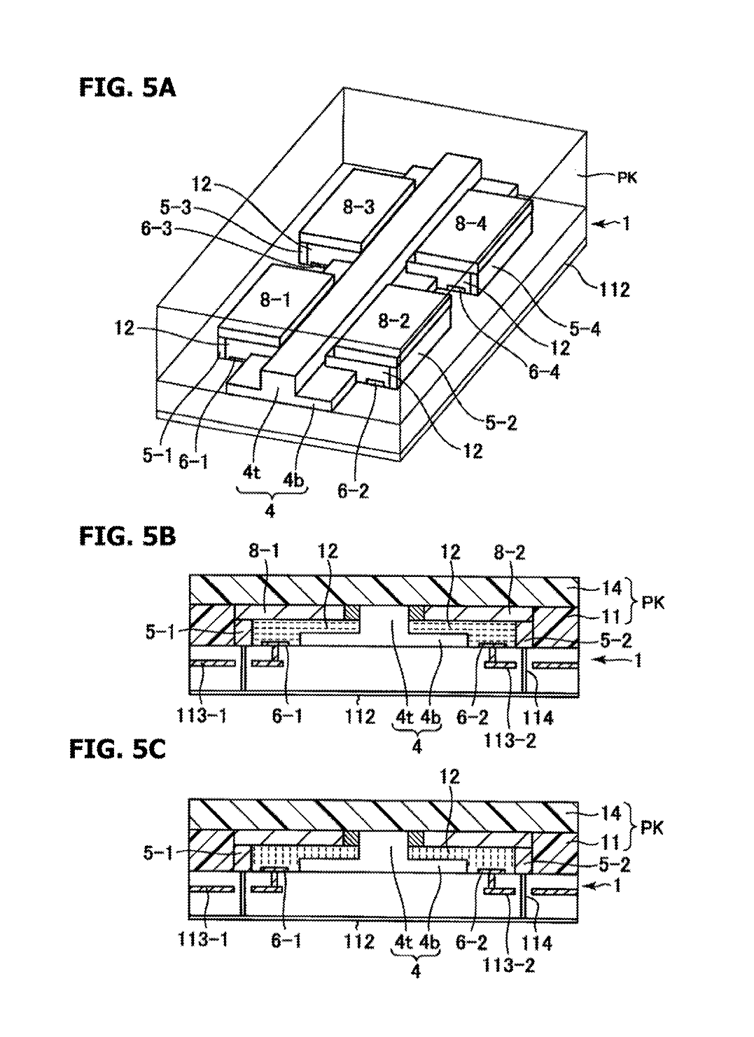

FIGS. 5A to 5C are views illustrating variable capacitor according to the second embodiment.

As illustrated in FIG. 5A, the high frequency line 4 includes a relatively wide bottom part 4b and a relatively narrow top part 4t disposed on a central part of the bottom part 4b. The bottom part 4b projects on both sides beyond the edge of the top part 4t. Four upper capacitance electrodes 8-1, 8-2, 8-3, and 8-4 are disposed on both sides of the top part 4t of the high frequency line 4, supported by conductive supports 5-1, 5-2, 5-3, and 5-4, and oppose toward or against the bottom part of the high frequency line 4, to establish variable capacitors. Driver electrodes 6-1, 6-2, 6-3, and 6-4 are formed on the LTCC substrate 1 between the bottom part 4b of the high frequency line 4 and the conductive supports 5-1, 5-2, 5-3, and 5-4. Liquid crystal 12 is filled in the space between the four upper electrodes 8-1, 8-2, 8-3, and 8-4 of the variable capacitors and the LTCC substrate. The outer periphery is covered with the resin package PK. The resin package PK, for example, may comprise, a resin region 11 surrounding the space where the liquid crystal is accommodated and the package layer 14 covering the upper electrodes and extending over the entire area as illustrated in FIG. 3K.

As illustrated in FIG. 5B, internal wirings 113-1, 113-2, and so on are formed in the interior of LTCC substrate 1, capable of supplying independent drive signals to the driver electrodes 6-1, 6-2, and so on. When the drive signal is not applied (0 V), the liquid crystal 12 is oriented along the alignment film in the direction parallel to the surface of the substrate 1 (or randomly when no alignment film is provided). In this case, the capacitances between the high frequency line 4 and the upper electrodes 8 are at relatively low value.

As illustrated in FIG. 5C, when the drive signal of, for example, 5 V to 10 V is applied to the driver electrodes 6-1, 6-2, and so on,

the liquid crystal molecules of the liquid crystal layer 12 stand up to be vertically oriented to the surface of the substrate. In this state, the capacitance between the high frequency line 4 and the upper electrodes 8 are at a relatively high value.

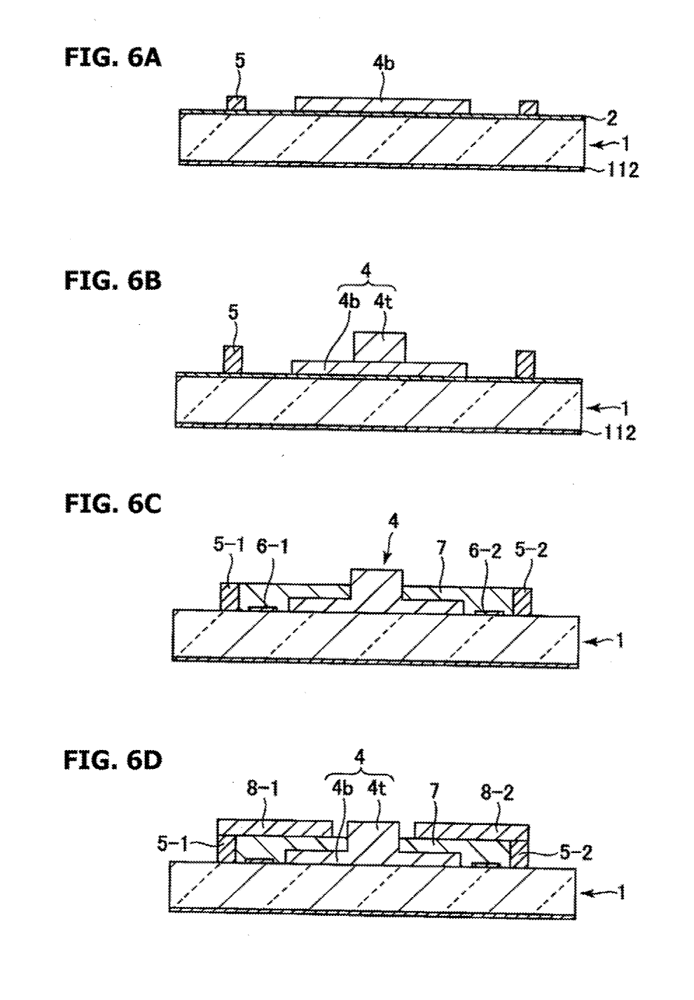

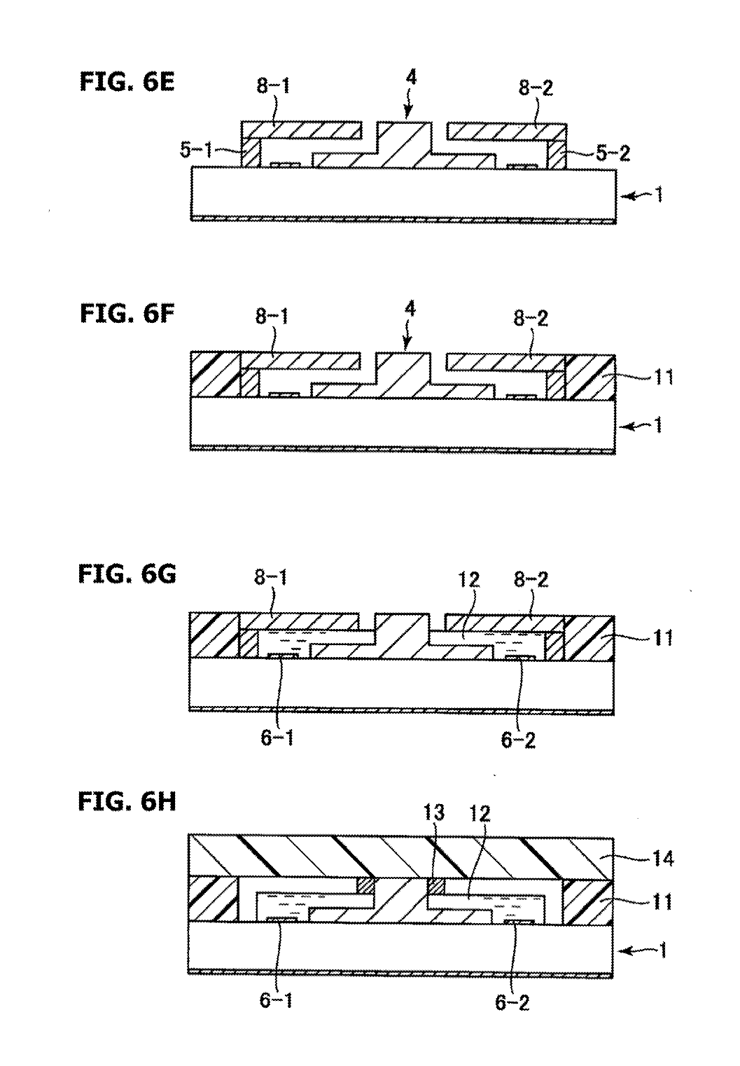

FIGS. 6A to 6H are cross-sectional views illustrating the processes for manufacturing the variable capacitor illustrated in FIG. 5A.

As illustrated in FIG. 6A, a gold seed layer 2 is formed by sputtering or the like on the surface of the LTCC substrate 1 having the ground conductor 112 on its rear surface, and the bottom part 4b of the high frequency line 4 and the lower parts of the conductive supports 5 are formed by gold plating on the selected regions of the gold seed layer 2 by using a resist pattern.

As illustrated in FIG. 6B, upper parts of the conductive supports 5 and a lower part of the top part 4t of the high frequency line 4 are formed by gold plating, using a resist pattern. A new resist pattern is formed, and an upper part of the top part 4t of the high frequency line 4 is formed by gold plating.

As illustrated in FIG. 6C, the driver electrodes 6-1, 6-2, and so on are patterned from the gold seed layer 2, using a resist pattern and conducing milling using Ar ions. A copper layer is sputtered to form a seed layer, and a dummy copper layer 7 is formed by electrolytic plating using a resist pattern, in spaces which become spaces between the electrodes of the variable capacitor.

As illustrated in FIG. 6D, the upper electrodes 8-1, 8-2, and so on are formed on the dummy copper layer 7 and the conductive supports 5 by gold plating using a resist pattern. The top part 4t of the high frequency line 4 is exposed between the upper electrodes 8-1 and 8-2and so on on both (left and right) sides.

As illustrated in FIG. 6E, the dummy copper layer 7 is selectively removed by etching. Upper electrodes of flexible cantilever structure (5 and 8) is formed.

As illustrated in FIG. 6F, a resin layer 11 surrounding the variable capacitance region is formed. For example, a photosensitive negative type polyimide resin layer is coated and exposed for development to leave the exposed part to thereby form the resin package region 11 surrounding the variable capacitance cell region.

As illustrated in FIG. 6G, liquid crystal 12 is introduced into the space between the electrodes of the variable capacitor. For example, the atmosphere is evacuated to vacuum, and the substrate is immersed in liquid crystal to carry out vacuum injection. Excess liquid crystal is removed by squeegee or the like.

As illustrated in FIG. 6H, sealing resin is filled in the inlet openings, and cured to form seal 13. A resin package layer 14 is formed to cover the upper electrodes 8-1, 8-2, and so on.

In the second embodiment, independent variable capacitors are formed on opposite sides of the high frequency line. More fine control of the distributed constant of a high frequency line would be enabled by increasing the number of the variable capacitors. Variable capacitance may be controlled as analog quantity, instead of on-off control.

Various modifications are possible also for the second embodiment.

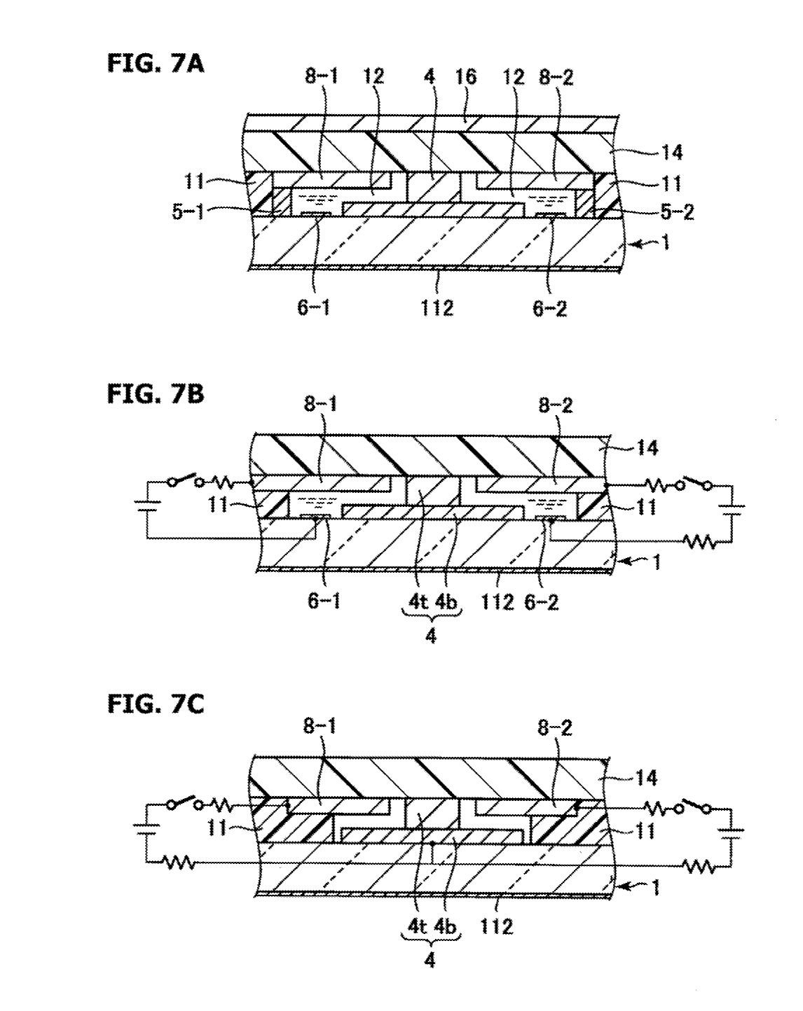

As illustrated in FIG. 7A, the second ground conductor 16 may be formed on a resin package layer 14 to form a strip line.

As illustrated in FIG. 7B, an insulated region 11 of a resin or the like defining the liquid crystal accommodating space may be formed on the substrate 1, and upper electrodes 8-1 and 8-2 may be formed on the insulated region 11. For example, a dc bias circuit may be connected between the upper electrode 8-i and the driver electrode 6-i via resistance.

As illustrated in FIG. 7C, the driver electrode may be dispensed with, as in the constitutions of FIGS. 4D to 4F. The drive voltage of the liquid crystal is applied by connecting a dc bias circuit between the high frequency line 4 and each of the upper electrodes 8-1 and 8-2 via resistance.

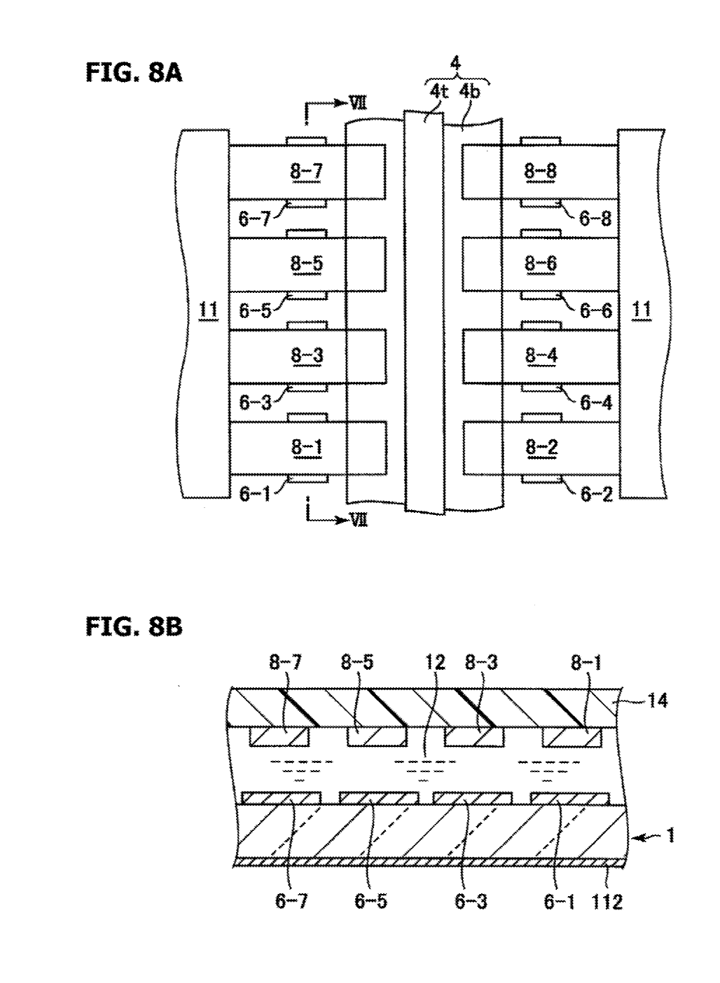

FIGS. 8A and 8B are views illustrating the third embodiment. Independent liquid crystal accommodating space is formed for each variable capacitor in the second embodiment illustrated in FIGS. 5A to 5C. In this embodiment, plural variable capacitors are formed along the high frequency line, and the liquid crystal accommodating space is shared by the plural variable capacitors.

FIG. 8A is a plan view of plural variable capacitors arranged along both sides of the high frequency line. A high frequency line 4 includes a bottom part 4b and a top part 4t,and extends on a substrate, along the vertical direction in FIG. 8A. Driver electrodes 6-1, 6-3, 6-5, and 5-7 are disposed on the substrate along the left side of the high frequency line 4, and driver electrodes 6-2, 6-4, 6-6, and 6-8 are disposed on the substrate along the right side of the high frequency line 4. The upper electrodes 8-1 to 8-8 of variable capacitors oppose or face against the driver electrodes 6-1 to 6-8, and partly overlap the bottom part 4b of the high frequency line 4, forming capacitors. Resin package region 11 outside the upper electrodes 8-1 to 8-8 defines liquid crystal accommodating space along the high frequency line 4.

FIG. 8B is a cross-sectional view taken along lines VII-VII in FIG. 8A. The driver electrodes 6-1, 6-3, 6-5, and 6-7 are formed on the LTCC substrate I provided with a ground conductor 112. The upper electrodes 8-1, 8-3, 8-5, and 8-7 supported by the conductive supports above the substrate oppose or face against the driver electrodes 6-1, 6-3, 6-5, and 6-7, respectively. The resin package layer 14 is formed on the upper surface of the upper electrodes 8-1, 8-3, 8-5, and 8-7. A liquid crystal accommodating space shared by plural variable capacitors is defined in the space between the substrate 1 and the resin package layer 14, and is filled with a liquid crystal layer 12. The liquid crystal has a dielectric constant higher than air and the package resin. Covering of the high frequency signal line 4 with the liquid crystal layer contributes to increase the capacitance and enable size reduction of the device. Structure of disposing a liquid crystal layer common to a plurality of capacitors can also be employed in other configurations.

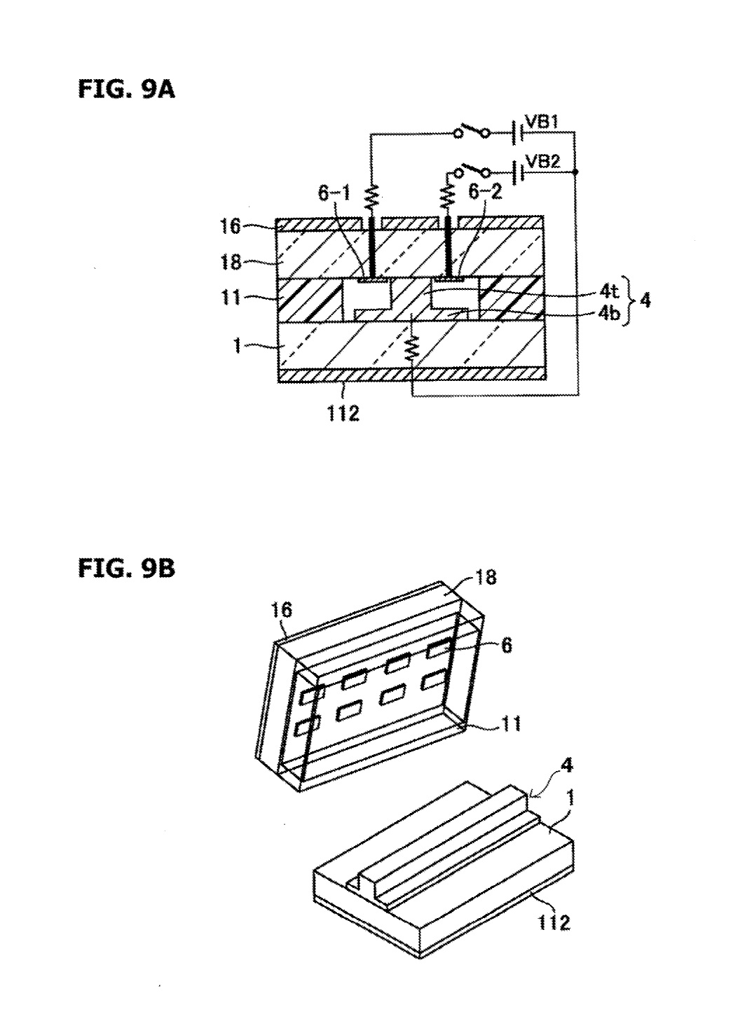

FIGS. 9A and 9B illustrate the fourth embodiment.

As illustrated in FIG. 9A, a strip line structure is constituted by using two LTCC substrates. The first LTCC substrate 1 has a first ground conductor 112 on the rear surface, and a high frequency line 4 on the front surface, to constitute a micro-strip structure. The high frequency line 4 has a configuration including a relatively wide bottom part 4b and a relatively narrow top part 4t disposed on the bottom part 4b, as in the case of the second embodiment illustrated in FIGS. 5A to 5C. The second LTCC substrate 18 has a second ground conductor 16 on a first surface, and driver electrodes 6-1 and 6-2 on a second surface. In the region between the driver electrodes 6-1 and 6-2 on the second LTCC substrate 18, the top parts 4t of the high frequency line 4 contacts the second LTCC substrate 18. The ground conductors 112 and 16 are disposed on both (lower and upper) sides of the high frequency line 4, constituting the strip structure. The driver electrodes 6-1 and 6-2 oppose or face against the bottom part 4b of the high frequency line 4, constituting capacitors. The resin seal region 11 defines the liquid crystal accommodating space between the substrates 1 and 18. Drive voltages VB1 and VB2 are applied between the high frequency line 4 and the driver electrodes 6-1 and 6-2 via resistances and wirings.

FIG. 9B is an assembling diagram of the constitution of FIG. 9A. The high frequency line 4 is formed on the first LTCC substrate 1, and the driver electrodes 6 and the resin seal region 11 are formed on the second LTCC substrate 18. A liquid crystal accommodating space common to a plurality of capacitors is formed. The first substrate 1 and the second substrate 18 are connected to form a strip line structure. Introduction of liquid crystal to the space between the electrodes may be performed, for example, by dropping droplets of the liquid crystal on the second substrate 18, and then connecting the first substrate 18 on the second substrate 1. Alternatively, a liquid crystal inlet opening may be formed in the substrate, and the liquid crystal may be introduced after the connecting the substrates.

In the fourth embodiment, the space between the high frequency line 4 and the first and second ground conductors 112 and 16 is mostly occupied by the ceramics of the substrate, and hence high frequency transmission characteristics would be secured.

Although description has been made along the embodiments, this invention is not limited thereto. For example, glass epoxy substrate may be used instead of the ceramic substrate.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What we claim are:

1. An electric device having a variable capacitance element comprising:
a dielectric substrate;
a high frequency signal line formed on a surface of the dielectric substrate;
a ground conductor disposed to oppose the high frequency signal line with at least part of the dielectric substrate intervening the ground conductor and the high frequency signal line;
upper electrode of capacitor disposed above the surface of the dielectric substrate, opposing the high frequency signal line; and
liquid crystal material filled in a space between the high frequency signal line and the upper electrode of capacitor.

2. An electric device according to claim 1, further comprising:
a pair of conductive supports formed on the surface of the dielectric substrate on both sides of the high frequency signal line, wherein
the upper electrode of capacitor is supported by the pair of conductive supports.

3. An electric device according to claim 2, further comprising:
wiring connecting the pair of conductive supports to a constant electric potential.

4. An electric device according to claim 1, further comprising:
a pair of conductive supports formed on the surface of the dielectric substrate on both sides of the high frequency signal line, wherein
the high frequency signal line has a relatively wide bottom part and a relatively narrow top part disposed on the bottom part, and
the upper electrode of capacitor has first and second portions disposed on both sides of the top part of the high frequency signal line and supported by the pair of conductive supports.

5. An electric device according to claim 1, further comprising:
a plurality of driver electrodes disposed on the surface of the dielectric substrate on both sides of the high frequency signal line and below the upper electrode of capacitor, wherein the liquid crystal material exists in regions between the driver electrodes and the upper electrode of capacitor; and
bias voltage circuit for applying drive voltage to the driver electrodes.

6. An electric device according to claim 5, further comprising a ground wiring for bias voltage circuit disposed in the dielectric substrate.

7. An electric device according to claim 5, further comprising an alignment film formed on the dielectric substrate covering the driver electrodes.

8. An electric device according to claim 1, wherein the liquid crystal material is nematic liquid crystal.

9. An electric device according to claim 1, further comprising:
a pair of insulated supports formed on the surface of the dielectric substrate on opposite sides of the high frequency signal line,
wherein the upper electrode of capacitor includes one electrode having two ends supported by the pair of insulated supports.

10. An electric device according to claim 1, further comprising:
a pair of insulated supports formed on the surface of the dielectric substrate on both sides of the high frequency signal line, wherein
the high frequency signal line has a relatively wide bottom part and a relatively narrow top part disposed on the bottom part, and
the upper electrode of capacitor has first and second portions disposed on both sides of the top part of the high frequency signal line, the first and second portions are supported by the pair of insulated supports.

11. A method for manufacturing an electric device having a variable capacitance element, comprising the steps of:
preparing a dielectric substrate having a ground conductor;
forming a high frequency signal line on a surface of the dielectric substrate;
forming an upper electrode of capacitor extending above the high frequency signal line, defining space for accommodating liquid crystal between the high frequency signal line and the upper electrode of capacitor; and
filling liquid crystal in the space for accommodating liquid crystal.
